(19) United States
(12) Patent Application Publication
(10) Pub. No.: US 2008/0312866 A1
(43) Pub. Date: Dec. 18, 2008

(54) THREE-DIMENSIONAL MEASURING EQUIPMENT

(76) Inventors: Katsunori Shimomura, Tokyo (JP); Isohachi Okamura, Tokyo (JP); Tetsuya Kajitani, Tokyo (JP); Keishin Okamura, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/571,505

(22) PCT Filed: Sep. 11, 2003
(86) PCT No.: PCT/JP2003/011621

§ 371 Date: Jun. 26, 2008

(51) Int. Cl. G06F 15/00

(52) U.S. Cl. 702/155

(57) ABSTRACT

One of the objects is to provide a three-dimensional measuring equipment for measuring a three-dimensional surface shape of an object efficiently with high accuracy. A three-dimensional data acquisition device comprises an object position measuring sensor for detecting the position of the object in a space, a measuring camera for capturing the object, and a measuring camera position measuring sensor for detecting the position of the measuring camera in the space. A three-dimensional data processing means comprises: controller means for delivering a parameter acquisition command to the object position measuring sensor and the measuring camera or the measuring camera position measuring sensor, for controlling the measuring camera based on parameters acquired from the object position measuring sensor and the measuring camera or the measuring camera position measuring sensor, and for acquiring measurement data by capturing the object image through the measuring camera; three-dimensional data calculating means for creating three-dimensional data; data processing means providing a three-dimensional display of the object; and storage means for storing the three-dimensional data.

### TECHNICAL FIELD

The present invention is related to a three-dimensional measuring equipment for measuring the three-dimensional surface shape of an object efficiently with high accuracy. More specifically, the present invention is related to a three-dimensional measuring equipment for measuring efficiently with high accuracy the three-dimensional surface shape of the outside and/or inside of an object in a simple and faster manner even when the object has a very complex three-dimensional surface shape or is moving.

### BACKGROUND OF THE INVENTION

There have been proposed many types of equipment for measuring the three-dimensional surface shape of an object such as the human body, while the most of them are very large. Recently, the down-sizing of the equipment has been attempted, and as one of attempts, a three-dimensional measuring equipment is disclosed in a Japanese Patent Laid-open Publication JP-A-2001-264035 (patent reference 1, herein below), in which a specific number of measuring heads (each comprised of a measuring camera and a light source) are arranged on a coplanar plane to shrink the size of measuring equipment a smaller size than ever, as well as to allow a high-speed measurement.

Although, while using the invention disclosed in said patent reference, the three-dimensional surface shape of the outside (contour) can be measured if the object to be measured is a jar, the three-dimensional surface shape of the inside of that jar may be difficult to be measured, since the measuring heads are fixedly arranged on a plane. Furthermore, when measuring a dead angle, such as when the object to be measured is a human body and the shape of armpit is to be measured, the arrangement of measurement head may become irregular if the measurement head is placed within the armpit, and a longer measuring time may be required.

In addition, the object to be measured has been so far assumed to be stationary, so that some parameter settings necessary for processing the measured data needed to be modified at each time the distance between the object and the measuring head changes. The measurement of moving object has been virtually impossible.

### SUMMARY OF THE INVENTION

The inventor of the present invention have invented a three-dimensional measuring equipment for measuring three-dimensional surface shape of an object efficiently with high accuracy, in a simple and high-speed manner, by arranging the measuring camera and light source in a given position within a predetermined space and considering the positional relationship in the space between the measuring camera and the object.

More specifically, the placement of the object is not limited as prior art, the object can be mounted in a given position within the space, and the light source and measuring camera can be placed in an arbitrary position within the space so that stripe pattern can be projected from the given position to the object and captured by the measuring camera to allow the efficient measurement with high accuracy of the three-dimensional surface shape of the object based on the fundamental of triangulation as usual, even when the fixed light source and/or measuring camera of the prior art cannot or has difficulty to capture the image.

The inventors of the present invention have also invented a three-dimensional measuring equipment, which, when the object to be measured is moving, allows the measurement of the moving object by moving the measuring camera and light source along with the object.

The invention in accordance with claim 1 provides a three-dimensional measuring equipment, comprising of a three-dimensional data acquisition device for measuring the three-dimensional surface shape of an object and a three-dimensional data processing device for generating three-dimensional data based on the measuring result,

said three-dimensional data acquisition device comprising:

a plurality of light sources each provided at a given position in a space, for projecting a stripe pattern onto said object;

a plurality of measuring cameras each provided at a given position in said space for capturing the stripe pattern projected onto said object and for detecting a part or all of the position, inclination, direction of light axis, magnification of the camera within said space,

said three-dimensional data processing device comprising:

controller means for directing said measuring cameras to obtain a part or all of parameters of the position, inclination, direction of light axis, magnification of said measuring cameras within said space, for obtaining said parameters from said measuring cameras, for extracting the combinations of said light source for projecting the stripe pattern to said object and said measuring camera for capturing said stripe pattern based on said parameters, for performing control of sequential order and measuring time of said measuring cameras for capturing, and for capturing the stripe pattern of said object by means of said measuring cameras, to thereby obtain the measuring data;

three-dimensional data calculating means for generating three-dimensional data based on said measuring data;

data processing means for performing three-dimensional display of said object based on said three-dimensional data; and

storage means for storing said three-dimensional data generated.

The invention in accordance with claim 2 provides a three-dimensional measuring equipment comprising of a three-dimensional data acquisition device for measuring the three-dimensional surface shape of an object and a three-dimensional data processing device for generating three-dimensional data based on the measuring result,

said three-dimensional data acquisition device comprising:

a plurality of light sources each provided at a given position in a space, for projecting a stripe pattern onto said object;

a plurality of measuring cameras each provided at a given position in said space, for capturing the stripe pattern projected onto said object; and

at least one or more measuring camera position measuring sensors each provided at a given position in said space, for detecting, part or all of the position, inclination, direction of light axis, magnification of said measuring cameras in said space,

said three-dimensional data processing device comprising:

controller means for directing said measuring camera position measuring sensors to obtain a part or all of parameters of the position, inclination, direction of light axis, and magnification of said measuring cameras in said space, for obtaining said parameters from said measuring camera position measuring sensors, for extracting the combination of said light source for projecting the stripe pattern onto said object and said measuring camera for capturing said stripe pattern, for performing the control of sequential order and measuring time of said measuring cameras for capturing, and for capturing the stripe pattern of said object by means of said measuring cameras, to thereby obtain the measuring data;

three-dimensional data calculating means for generating three-dimensional data based on said measuring data;

data processing means for performing three-dimensional display of said object based on said three-dimensional data; and

storage means for storing said three-dimensional data generated.

The invention in accordance with claim 3 provides a three-dimensional measuring equipment, comprising a three-dimensional data acquisition device for measuring the three-dimensional surface shape of an object and a three-dimensional data processing device for generating three-dimensional data based on the measuring result,

said three-dimensional data acquisition device comprising:

at least one or more object position measuring sensors each provided at a given position in a space for detecting the position of said object in said space;

a plurality of light sources each provided at a given position in a space, for projecting a stripe pattern onto said object; and

a plurality of measuring cameras each provided at a given position in said space, for capturing said stripe pattern projected to said object and for detecting a part or all of parameters of the position, inclination, direction of light axis, and magnification of the camera in said space,

said three-dimensional data processing device comprising:

controller means for directing said object position measuring sensor and said measuring cameras to obtain a part or all of the parameters of the position of said object in said space, the position, inclination, direction of light axis, magnification of said measuring camera in said space, for obtaining said parameters from said object position measuring sensors and said measuring cameras, for extracting the combination of the light source projecting the stripe pattern onto said object and said measuring camera capturing said stripe pattern based on said parameters, for performing the control of sequential order and measuring time of capturing said measuring cameras for capturing, and for capturing the stripe pattern of said object by means of said measuring cameras, to thereby obtain the measuring data;

three-dimensional data calculating means for generating three-dimensional data based on said measuring data;

data processing means for performing three-dimensional display of said object based on said three-dimensional data; and

storage means for storing said three-dimensional data generated.

The invention in accordance with claim 4 provides a three-dimensional measuring equipment comprising of a three-dimensional data acquisition device for measuring the three-dimensional surface shape of an object and a three-dimensional data processing device for generating three-dimensional data based on the measuring result,

said three-dimensional data acquisition device comprising:

at least one or more object position measuring sensors each provided at a given position in a space, for detecting the position of said object in said space;

a plurality of light sources each provided at a given position in said space, for projecting a stripe pattern onto said object;

a plurality of measuring cameras each provided at a given position in said space, for capturing the stripe pattern projected onto said object; and

at least one or more measuring camera position measuring sensors each provided at a given position in said space, for detecting part or all of the parameters of the position, inclination, direction of light axis, magnification of said measuring cameras in said space,

said three-dimensional data processing device comprising:

controller means for directing said object position measuring sensors and said measuring camera position measuring sensors to obtain a part or all of the parameters of the position of said object in said space, and the position, inclination, direction of light axis, magnification of said measuring cameras in said space, for obtaining said parameters from said object position measuring sensors and said measuring camera position measuring sensors, for extracting the combination of said light source projecting the stripe pattern onto said object and said measuring camera capturing said stripe pattern based on said parameters, for performing the control of sequential order and measuring time of capturing said measuring cameras for capturing, and for capturing the stripe pattern of said object by said measuring camera, to thereby obtain measuring data;

three-dimensional data calculating means for generating three-dimensional data based on said measuring data;

data processing means for performing three-dimensional display of said object based on said three-dimensional data; and

storage means for storing said three-dimensional data generated.

The invention in accordance with claim 12 provides a three-dimensional data acquisition device for performing the measurement of the three-dimensional surface shape of an object under the control of a three-dimensional data processing device, for generating three-dimensional data,

said three-dimensional data acquisition device comprising:

a plurality of light sources each provided at a given position in a space, for projecting a stripe pattern onto said object;

a plurality of measuring cameras each provided at a given position in said space, for capturing the stripe pattern projected onto said object and for detecting a part or all of the parameters of the position, inclination, direction of light axis, magnification of the camera in said space.

The invention in accordance with claim 13 provides a three-dimensional data acquisition device for performing the measurement of the three-dimensional surface shape of an object under the control of a three-dimensional data processing device, for generating three-dimensional data,

said three-dimensional data acquisition device comprising:

a plurality of light sources each provided at a given position in a space, for projecting a stripe pattern onto said object;

a plurality of measuring cameras each provided at a given position in said space, for capturing the stripe pattern projected onto said object;

at least one or more measuring camera position measuring sensors each provided at a given position in said space, for detecting a part or all of the parameters of the position, inclination, direction of light axis, magnification of said measuring camera in said space.

The invention in accordance with claim 14 provides a three-dimensional data acquisition device for performing the measurement of the three-dimensional surface shape of an object under the control of a three-dimensional data processing device, for generating three-dimensional data, comprising:

at least one or more object position measuring sensors each provided at a given position in a space, for detecting the position of said object in said space,

a plurality of light sources each provided at a given position in said space, for projecting a stripe pattern onto said object;

a plurality of measuring cameras each provided at a given position in said space, for capturing the stripe pattern projected onto said object and for detecting a part or all of the parameters of the position, inclination, direction of light axis, magnification of the camera in said space.

The invention in accordance with claim 15 provides a three-dimensional data acquisition device for performing the measurement of the three-dimensional surface shape of an object under the control of a three-dimensional data processing device, for generating three-dimensional data, comprising:

at least one or more object position measuring sensors each provided at a given position in a space, for detecting the position of said object in said space;

a plurality of light sources each provided at a given position in said space, for projecting a stripe pattern onto said object;

a plurality of measuring cameras each provided at a given position in said space, for capturing the stripe pattern projected onto said object; and

at least one or more measuring camera position measuring sensors each provided at a given position in said space, for detecting a part or all of the parameters of the position, inclination, direction of light axis, magnification of said measuring camera in said space.

The invention in accordance with claim 18 provides a three-dimensional data processing device for generating three-dimensional data based on the result obtained from a three-dimensional data acquisition device for capturing the three-dimensional surface shape of an object,

said three-dimensional data processing device comprising:

controller means for directing a plurality of measuring cameras each provided at a given position in a space of said three-dimensional data acquisition device for capturing the stripe pattern of said object projected by a plurality of light sources each provided at a given position in said space of said three-dimensional data acquisition device for projecting the stripe pattern onto said object, and for detecting a part or all of the parameters of its position, inclination, direction of light axis, magnification in said space to obtain a part or all of the parameters of the position, inclination, direction of light axis, magnification of said measuring cameras in said space, for obtaining said parameters from said measuring cameras, for extracting the combination of the light source projecting the stripe pattern onto said object and said measuring camera capturing said stripe pattern, based on said parameters, for performing the control of sequential order and measuring time of said measuring cameras for capturing, and for capturing the stripe pattern of said object by means of said measuring cameras, to thereby obtain measuring data;

three-dimensional data calculating means for generating three-dimensional data based on said measuring data;

data processing means for performing three-dimensional display of said object based on said three-dimensional data; and

storage means for storing said three-dimensional data generated.

The invention in accordance with claim 19 provides a three-dimensional data processing device for generating three-dimensional data based on the result obtained from a three-dimensional data acquisition device for capturing the three-dimensional surface shape of an object,

said three-dimensional data processing device comprising:

controller means for directing measuring camera measuring position sensors for detecting a part or all of parameters of the position, inclination, direction of light axis, magnification, in a space of said three-dimensional data acquisition device, of a plurality of measuring cameras each provided at a given position in said space of said three-dimensional data acquisition device for capturing the stripe pattern of said object projected thereon by a plurality of light sources each provided at a given position in said space of said three-dimensional data acquisition device for projecting the stripe pattern onto said object to obtain a part or all of the parameters of the position, inclination, direction of light axis, magnification of said measuring cameras in said space, for obtaining said parameters from said measuring camera measuring position sensors, for extracting the combination of the light source projecting the stripe pattern onto said object and said measuring camera capturing said stripe pattern based on said parameters, for performing the control of sequential order and measuring time of said measuring cameras for capturing, and for capturing the stripe pattern of said object by means of said measuring cameras, to thereby obtain measuring data;

three-dimensional data calculating means for generating three-dimensional data based on said measuring data;

data processing means for performing three-dimensional display of said object based on said three-dimensional data; and

storage means for storing said three-dimensional data generated.

The invention in accordance with claim 20 provides a three-dimensional data processing device for generating three-dimensional data based on the result obtained from a three-dimensional data acquisition device for capturing the three-dimensional surface shape of an object,

said three-dimensional data processing device comprising:

controller means for directing at least one or more object position measuring sensors each provided at a given position in a space of said three-dimensional data acquisition device for detecting the position of said object and a plurality of measuring cameras each provided at a given position in said space of said three-dimensional data acquisition device for capturing the stripe pattern of said object projected by a plurality of light sources each provided at a given position in said space of said three-dimensional data acquisition device for projecting the stripe pattern onto said object and for detecting a part or all of the parameters of its position, inclination, direction of light axis, magnification in said space to obtain part or all of the parameters of the position of said object in said space, and the position, inclination, direction of light axis, magnification of said measuring cameras in said space, for obtaining said parameters from said object position measuring sensors and said measuring cameras, for extracting the combination of the light source projecting the stripe pattern onto said object and said measuring camera capturing said stripe pattern based on said parameters, for performing the control of sequential order and measuring time of said measuring cameras for capturing, and for capturing the stripe pattern of said object by means of said measuring cameras, to thereby obtain said measuring data;

three-dimensional data calculating means for generating three-dimensional data based on said measuring data;

data processing means for performing three-dimensional display of said object based on said three-dimensional data; and

storage means for storing said three-dimensional data generated.

The invention in accordance with claim 21 provides a three-dimensional data processing device for generating three-dimensional data based on the result obtained from a three-dimensional data acquisition device for capturing the image of the three-dimensional surface shape of an object,

said three-dimensional data processing device comprising:

controller means for directing at least one or more object position measuring sensors each provided at a given position in a space of said three-dimensional data acquisition device for detecting the position of said object and a plurality of measuring camera measuring position sensors each provided at a given position in said space of said three-dimensional data acquisition device for detecting a part or all of the parameters of the position, inclination, direction of light axis, magnification, in said space of said three-dimensional data acquisition device, of a plurality of measuring cameras each provided at a given position in said space of said three-dimensional data acquisition device for capturing the stripe pattern of said object projected by a plurality of light sources each provided at a given position in said space of said three-dimensional data acquisition device for projecting the stripe pattern onto said object to obtain a part or all of the parameters of the position of said object in said space and the position, inclination, direction of light axis, magnification of said measuring cameras in said space, for obtaining said parameters from said object position measuring sensors and said measuring camera measuring position sensors, for extracting the combination of the light source projecting the stripe pattern onto said object and said measuring camera capturing said stripe pattern based on said parameters, for performing the control of the sequential order and measuring time of said measuring cameras for capturing, and for capturing the stripe pattern of said object by means of said measuring cameras to obtain measuring data;

three-dimensional data calculating means for generating three-dimensional data based on said measuring data;

data processing means for performing three-dimensional display of said object based on said three-dimensional data; and

storage means for storing said three-dimensional data generated.

In the present invention above mentioned, the measuring cameras each may be placed at a given position in a space, so that even the image of an object having a complex surface shape may be captured by displacing appropriately the position of the measuring camera and light source. In the invention in accordance with claim 1, claim 3, claim 12, claim 14, claim 18 and claim 20, the measuring camera acquires the position of the measuring camera in the space in order to eliminate the need of sensors for measuring the measuring camera. In particular, in the invention in accordance with claim 1, claim 12, and claim 18, the object position measuring sensors themselves are eliminated by fixing the placement position of the object in the space. More specifically, as the object is fixedly placed, the combinations of a measuring camera and a light source which permits no overlap of light source can be calculated. In the invention in accordance with claim 3, claim 14, and claim 20, the position of the object is detected by using the object position measuring sensor to permit the object to be placed at an arbitrary position in the space. This provides the flexibility of capturing the image without the need of taking care of the placement position of the object.

In the invention in accordance with claim 2, claim 4, claim 13, claim 15, claim 19, and claim 21, the measuring camera position measuring sensor for measuring the measuring camera is provided to eliminate the processing of sensing the position of measuring cameras so as to reduce the burden on the measuring camera, as well as to allow detection of the position of measuring cameras provided at a given position and capturing the image by automatically using the sensor.

The invention in accordance with claim 5 provides a three-dimensional measuring device in which said measuring camera moves under the control of said controller means based on the position of said object detected by said object position measuring sensor to capture said stripe pattern.

The invention in accordance with claim 6 provides a three-dimensional measuring device in which said measuring camera tilts, changes the direction of light axis as well as the magnification under the control of said controller means based on the position of said object detected by said object position measuring sensor to capture said stripe pattern.

The invention in accordance with claim 16 provides a three-dimensional data acquisition device in which said measuring camera moves under the control of said controller means based on the position of the object detected by said object position measuring sensor to capture said stripe pattern.

The invention in accordance with claim 17 provides a three-dimensional data acquisition device in which said measuring camera captures said stripe pattern while modifying its inclination, direction of light axis, and magnification under the control of said controller means based on the position of the object detected by said object position measuring sensor.

The present invention as mentioned above allows the camera to pursuit while capturing the image of the object when the object is moving, by displacing the measuring camera itself or modifying the inclination of the measuring camera and so.

The present invention in accordance with claim 7 provides a three-dimensional measuring equipment in which said three-dimensional data calculating means performs the conversion of point-group data based on said measuring data, the rotation and translation after conversion, then synthesis and smoothing processing in order to generate three-dimensional data.

The present invention in accordance with claim 22 provides a three-dimensional data acquisition device in which said three-dimensional data calculating means performs the conversion of point-group data based on said measuring data, the rotation and translation after conversion, then synthesis and smoothing processing in order to generate three-dimensional data.

The present invention in accordance with claim 7 and claim 22 as mentioned above allows the generation of the three-dimensional data of the object.

The present invention in accordance with claim 8 provides a three-dimensional measuring equipment in which said controller means extracts the combinations of said light source and said measuring camera so as to selectively extract some combinations such that the stripe patterns projected by said light source do not overlap with each other on said object.

The present invention in accordance with claim 9 provides a three-dimensional measuring equipment in which, when said controller means extracts the combinations of said light source and said measuring camera, said measuring camera is equipped with a lens or filter that blocks the light of a specific frequency, or a color filter that blocks a specific color so as to appropriately extract some combinations of said light source and said measuring camera.

The present invention in accordance with claim 10 provides a three-dimensional measuring equipment in which said measuring camera is equipped with a lens or filter for extracting a specific phase and said controller means controls the on-off, in a time-division manner, of the function of said lens or filter for extracting a specific phase.

The present invention in accordance with claim 11 provides a three-dimensional measuring equipment in which said controller means performs control of said measuring camera based on the color information in said measuring data.

The present invention in accordance with claim 23 provides a three-dimensional measuring equipment in which said controller means extracts the combination of said light source and said measuring camera so as to selectively extract some combinations such that the stripe patterns projected by said light source do not overlap with each other on said object.

The present invention in accordance with claim 24 provides a three-dimensional measuring equipment in which when said controller means extracts the combinations of said light source and said measuring camera, said measuring camera is equipped with a lens or filter that blocks the light of a specific frequency, or a color filter that blocks a specific color so as to appropriately extract some combination of said light source and said measuring camera.

The present invention in accordance with claim 25 provides a three-dimensional data processing device in which said measuring camera is equipped with a lens or filter for extracting a specific phase and said controller means performs control of the on-off, in a time-division manner, of the function of the lens or filter for extracting a specific phase.

The present invention in accordance with claim 26 provides a three-dimensional data processing device in which said controller means performs control of said measuring camera based on the color information in said measuring data.

The invention in accordance with claim 8 and claim 23 allows the capturing of image of high accuracy measuring data by selecting a combination such that the stripe patterns do not overlap with each other when the light source projects on the subject to create the stripe pattern on it. The invention in accordance with claim 9 and claim 24, on the other hand, allows any overlap of the stripe patterns projected on the object because the measuring camera is equipped with a lens or filter that blocks the light of a specific frequency or a color filter that blocks a specific color in order to eliminate the influence of the overlap (interference) while collecting the measuring data. The light sources and measuring cameras, which have been both fixedly installed in the prior art, may be placed at arbitrary places without taking care of the overlap of the stripe patterns. In the invention in accordance with claim 10 and claim 25, as has been described above, in addition to the extraction of specific frequency, a lens or filter that extracts a specific phase is provided so as to eliminate the influence of the interference to generate better measuring data. In this case the controller means may control the phase extraction in a time-division manner. More specifically, the control is such that it extracts a specific phase at one time, and does not extract the phase at another time. Furthermore, in the invention in accordance with claim 11 and claim 26, since the present invention may capture the texture as measuring data, the control of measuring camera itself can be done based on the color information contained in the texture. This type of control includes among others the on-off of the switch of measuring camera and magnification control.

### BRIEF DESCRIPTION OF THE DRAWINGS

FIG. 1 shows a schematic diagram of a system illustrating an embodiment of the system configuration in accordance with the present invention;

FIG. 2 shows a schematic block diagram illustrating an embodiment of the process flow in accordance with the present invention;

FIG. 3 shows a schematic diagram when a jar is the object;

FIG. 4 shows a schematic diagram illustrating the combination and the image capturing sequence when using the measuring camera as shown in FIG. 1;

FIG. 5 shows a system overview illustrating a plurality of three-dimensional data acquisition devices continuously arranged;

FIG. 6 shows a schematic diagram when some light sources and the same number of measuring cameras are used;

FIG. 7 shows a schematic diagram when a laser light source is used to project a stripe pattern on a subject;

FIG. 8 shows a side view illustrating an example of measuring camera and its projection pattern from one side;

FIG. 9 shows a schematic diagram when a halogen light source is used as light source to project a stripe pattern on an object;

FIG. 10 shows a schematic diagram illustrating the generation of three-dimensional data from the stripe pattern;

FIG. 11 shows a schematic diagram illustrating the capturing the image of a human body by means of a three-dimensional data acquisition device;

FIG. 12 shows a schematic diagram illustrating three-dimensional data; and

FIG. 13 shows a schematic diagram illustrating the generation of a movie data.

### REFERENCE NUMERALS

1: three-dimensional measuring equipment
2: three-dimensional data acquisition device
3: three-dimensional data processing device
4: controller means
5: data processing means
6: three-dimensional data calculating means
7: storage means
8: measuring camera
9: measuring camera position measuring sensor
10: object position measuring sensor
11: slit
12: polygon mirror
13: cylindrical lens
14: light source
15: stripe pattern

### BEST MODE FOR CARRYING OUT THE INVENTION

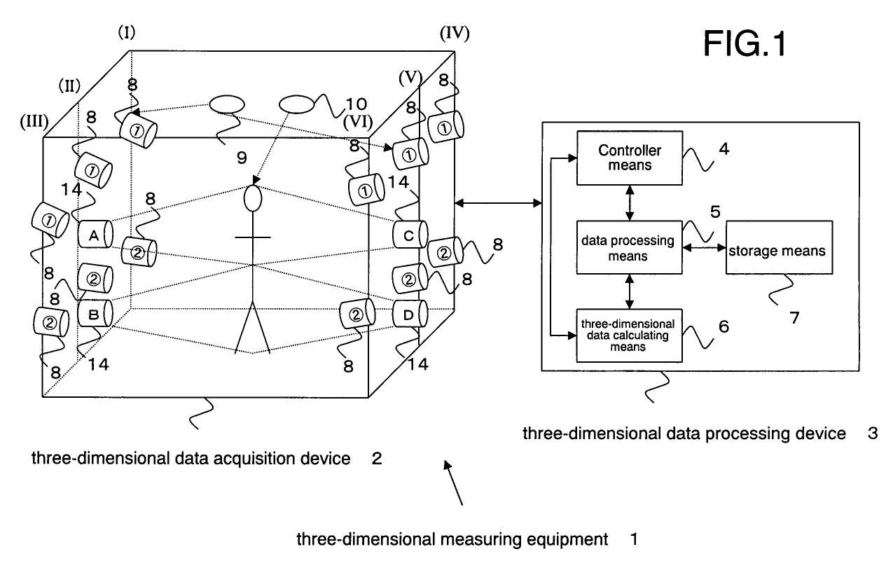

Now referring to FIG. 1, there is shown a schematic diagram of an exemplary system configuration in accordance with the present invention. A three-dimensional measuring equipment 1 includes a three-dimensional data acquisition device 2, and a three-dimensional data processing device 3 for generating three-dimensional data of an object based on the data of the measuring result (data may be three-dimensional coordinates, texture data, wire-frame, etc.).

The three-dimensional data acquisition device 2 is a device that captures the image of the object to obtain three-dimensional data, which includes a plurality of measuring camera 8 and light source 14 each provided at a given position in a space. There can be a case in which at least one or more object position measuring sensors 10 and measuring camera position measuring sensors 9 may be provided at a given position in the space.

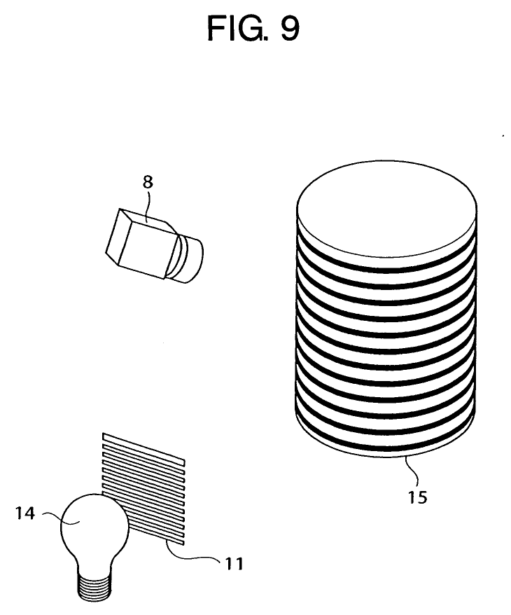

There are a plurality of light sources 14 provided at given positions in the space, each projecting a stripe pattern 15 onto the object. The stripe pattern 15 in this case can be either in the vertical, horizontal, or any other direction. For the light source 14, a halogen light source and a laser light source are both suitable. When a halogen light source is used as the light source 14, a slit 11, for projecting a stripe onto the object, is placed between the light source 14 and the object in order to project a stripe pattern 15 onto the object. By adjusting the width of slit, the width of the stripe pattern 15 projected on the object can be adjusted, and narrower the slit width is, higher the accuracy of the three-dimensional data created. FIG. 9 shows a schematic diagram illustrating a halogen light source used as the light source 14 for projecting the stripe pattern 15 onto the object.

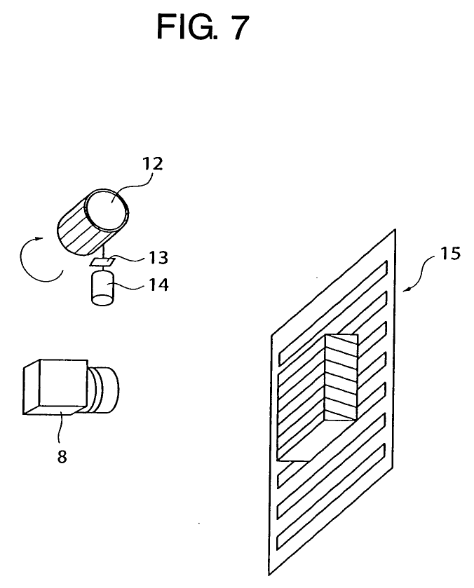

When a laser light source is used for the light source 14, the light emitted from the laser light source and modulated in time-series are collimated by a cylindrical lens 13 onto a polygonal mirror 12, and the rotating polygonal mirror 12 sweeps the light and scans so that the stripe pattern 15 as shown in FIG. 7 is projected on the object in correspondence to the surface shape of the object. FIG. 7 shows a schematic diagram illustrating the projection of the stripe pattern 15 onto an object by means of a laser light source as the light source 14.

When a halogen light source is used as the light source 14, there will be no risk to harm the object even when the light beam is projected onto the human face, for example. On the other hand, when a laser light source is used as the light source 14, the rectilinearity of the laser beam permits detailed adjustment of the extent of the object to which the stripe pattern 15 is to be projected. Because the adjustment of the projection extent thereof is easy, simultaneous use of the light source 14 and the measuring camera 8 is allowed so as not to overlap the stripe patterns. This reduces the time required for capturing the image.

If the light interference occurs when two stripe patterns 15 overlap each other on the object by using simultaneously or at nearly same time the light source 14 and the measuring camera 8, one solution is to mount a lens or a filter that performs the time-division, space-division, or the combination thereof on each measuring camera 8. The term time-division means a method that a lens or a filter that blocks the light of a given frequency or a lens or a filter that extracts a specific phase is used so as to prevent the interference, which is achievable by altering the frequency of light emitted from the light source 14. The space-division, on the other hand, means a method that uses a color filter attached on the measuring camera 8 to prevent the interference of opposing light sources 14, which is achievable by changing the color of light emitted from the light source 14. By using any one of such methods, even when interference occurs, (two stripe patterns 15 overlap each other), and the measuring camera 8 may capture the stripe pattern 15 projected onto the object from the most appropriate light source 14. When doing this, the controller means 4 of the three-dimensional data processing device 3 may control in the time domain the lens or filter as mentioned above to work or not to work the function of transmission of light of a specific frequency and the function of extraction of a specific phase (on-off control of the function for a specific period of time).

As disclosed in the patent mentioned in the prior art patent reference 1, in the conventional technique, the positions of the measuring camera 8 and the light source 14 are often fixed. The interference of the light from the light source 14 can be estimated in some extent, however, in case of an equipment which allows placement of the measuring camera 8 and the light source 14 at given positions in the space, which is one of characteristics of the present invention, the interference among the lights from the light sources 14, which changes each time by the placement, will be difficult to estimate. Therefore it will be very effective to use the measuring camera 8 having the time-division or space-division functionality as mentioned above for preventing the interference.

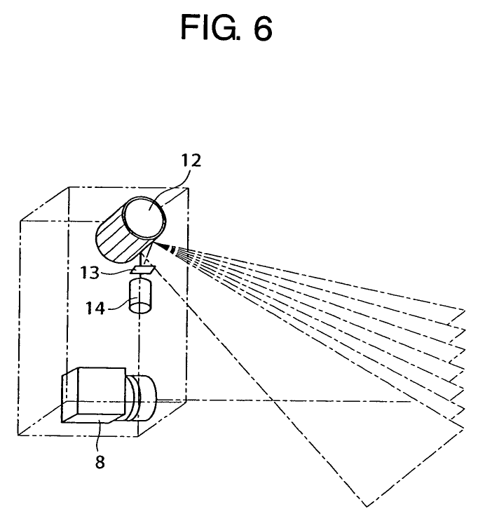

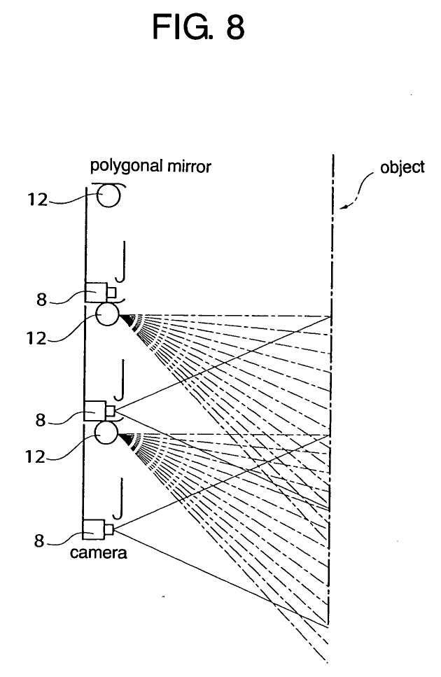

A plurality of measuring cameras 8 are provided each at a given position in the space, which capture the stripe pattern 15 projected onto the object. The measuring cameras 8, which capture the stripe pattern projected onto the object from the light source 14, transmit as measuring data to the three-dimensional data processing device 3. The same number of the measuring cameras 8 may be provided as that of the light sources 14 as one-to-one basis or any different number of cameras may also be provided. FIG. 6 shows a schematic diagram when the light source 14 is a laser light source, and the same number of the measuring cameras 8 as that of the light sources 14 are provided. FIG. 8 shows a side view when the light source 14 is a laser light source, the same number of the measuring cameras 8 as that of the light sources 14 are provided as one-to-one basis, and the stripe pattern 15 from the light source 14 is projected onto the object. The measuring camera 8, for preventing the interference among the lights from the light sources 14 as mentioned above, must have a lens or a filter for enabling the time-division and/or space-division.

The measuring camera 8 may also be arranged so as to detect the position, inclination, direction of light axis, and magnification of the measuring camera 8 in the space by means of a gyroscope or the like.

The measuring camera 8 is capable of transmitting and receiving data to and from the three-dimensional data processing device 3, and when the object is moving, the measuring camera 8, under the control of the controller means 4 (will be described later) of the three-dimensional data processing device 3 based on the position data of the object that the object position measuring sensor 10 is tracing, will trace the moving object to capture the stripe pattern 15 projected onto the object. The tracing may be done by moving the measuring camera 8 itself, or by changing the inclination, direction of light axis, magnification of the measuring camera 8 without displacing the camera position to trace for capturing the image.

At least one object position measuring sensor 10 or more may be provided at given positions in the space, for detecting the position of the object in the space. The object position measuring sensor 10 alternatively may be arranged so as to trace the displacement of the object.

The three-dimensional data acquisition device 2 may have at least one measuring camera position measuring sensor 9 or more each provided at a given position in the space if the measuring camera 8 does not detect the position, inclination, direction of light axis, magnification of the measuring camera 8 within the space. The measuring camera position measuring sensor 9 is a sensor for detecting the position, inclination, direction of light axis, and magnification of the measuring camera 8 in the space.

Although in the system overviews shown in the drawings herein, some arrangements are shown in which the measuring camera 8 itself does not detect the position, inclination, direction of light axis, magnification of the measuring camera 8 in the space but the measuring camera position measuring sensor 9 is provided in the space to detect the position, inclination, direction of light axis, magnification of the measuring camera 8, it is conceivable that a gyroscope and the like can be mounted on the measuring camera 8 as have been described above to detect the position, inclination, direction of light axis, magnification of the measuring camera 8 in the space by the measuring camera 8 itself.

The three-dimensional data processing device 3 is a device for generating three-dimensional data of the object (three-dimensional coordinates, texture data, wire-frame, and so on) based on the measuring data obtained by the three-dimensional data acquisition device 2, and includes controller means 4, data processing means 5, three-dimensional data calculating means 6, and storage means 7.

The controller means 4 is the means for directing the three-dimensional data acquisition device 2 to detect the position of the object in the space as well as the position, inclination, direction of light axis, magnification of the measuring camera 8 in the space, for obtaining these parameters from the object position measuring sensor 10, the measuring camera 8, or the measuring camera position measuring sensor 9, for performing the control of the combination and measuring time of the light source 14 and the measuring camera 8, and for capturing the image of the object by means of measuring camera 8, to obtain measuring data.

The controller means 4, after obtaining the measuring data of the object from the measuring camera 8 of the three-dimensional data processing device 3, performs a filtering, transmits data to the three-dimensional data calculating means 6, and instructs to generate three-dimensional data.

The three-dimensional data calculating means 6 is the means which, upon reception of measuring data from the controller means 4, generates three-dimensional data such as three-dimensional coordinates, texture data, and wire-frame, to transmit these data to the data processing means 5. When generating three-dimensional data from the measuring data, the point-group data is converted based on the filtered measuring data, then each of data items is rotated/translated thereon, then synthesized and smoothen to create the contour line data (i.e., three-dimensional data). To do this, any one of known technique may be applied.

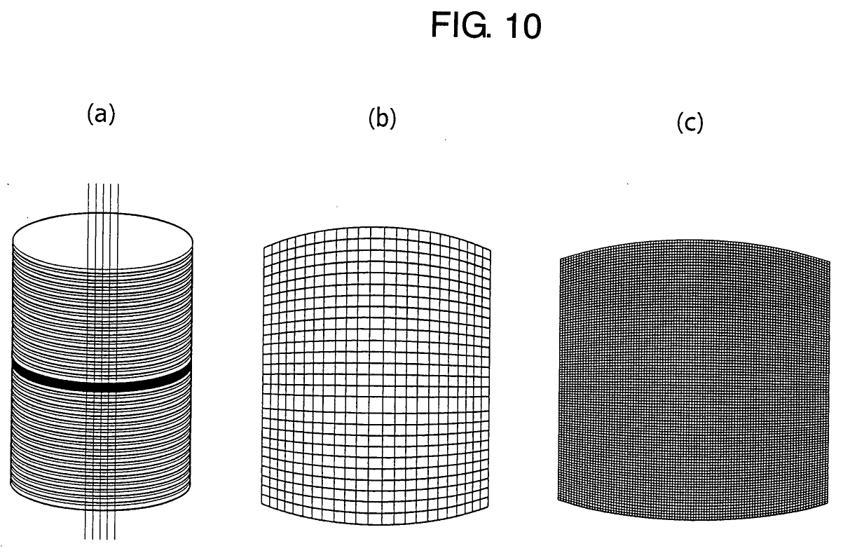

More specifically, the measuring data (image) of the stripe pattern 15 captured by the measuring camera 8 is processed to extract the stripe position, then detect the amount of deviation of the point from the reference point to derive three-dimensional data based on the coordinate equation. For instance, when measuring a cylindrical column as shown in FIG. 9, the measuring data the image of which is captured (image) is vertically scanned at a given interval to extract the centers of either white stripes or black stripes to detect the amount of deviation from the ideally original position of the stripes (the position to be projected on a reference plane, or the position projected onto the background). The depth may be calculated based on the principle of triangulation. By substituting the deviation and the two-dimensional coordinates of the center into the equation to obtain the three-dimensional data. When such a method is used, the coordinate density in the horizontal direction will depend on the resolution (for example, 512 pixels) of the measuring data (image), and the density in the vertical direction will depend on the number of stripes projected. Accordingly in order to improve the resolution in the vertical direction, the width of the stripe pattern 15 should be narrowed. The schematic diagram of the case is shown in FIGS. 10 (a) and (b).

When the width of the stripe pattern 15 is narrower, the extraction of the center of the stripe will be difficult if the width is made narrower (particularly in case of an object having a complex shape), so that there is a limit. To overcome this limitation, the three-dimensional data calculating means 6 calculates the coordinates based on a plurality of shots (preferably four) of measuring data (images) with the generated grid being shifted by an arbitrary amount based on the stripe pattern 15 projected (this is referred to as stripe scan method). By using the stripe scan method the density of the stripe will be normalized from a plurality of shots of measuring data (images) to detect the phase of the stripes, allowing the coordinates of every points on the measuring data (images) to be calculated as shown in FIG. 10 (c). In addition, during the normalization of the stripes, the effect of any design pattern on the surface of the object can be eliminated. Because the scanning of the stripe may allow it to obtain the amount of deformation of the stripes that are used as the basis of the coordinate calculation at a higher sensitivity, many detailed irregularities can be detected.

Furthermore, only one image may be used to derive three-dimensional data calculation at a higher density. This can be achieved by using the methodology of frequency analysis, by calculating the coordinates from the grid projected on one image. This allows a moving object to be measured. In addition, the image of the stripe pattern 15 may also be filtered in the controller means 4 to remove the noise component to extract only the stripe information to eliminate the effect of the design pattern, while calculating the coordinates on the entire captured area.

The data processing means 5 is a means for directing the measurement instruction to the controller means 4 in order to start the measurement of the object. The data processing means 5 also performs three-dimensional display of the object based on the three-dimensional data received from the three-dimensional data calculating means 6.

The storage means 7 is a means for storing the three-dimensional data generated by the three-dimensional data calculating means 6.

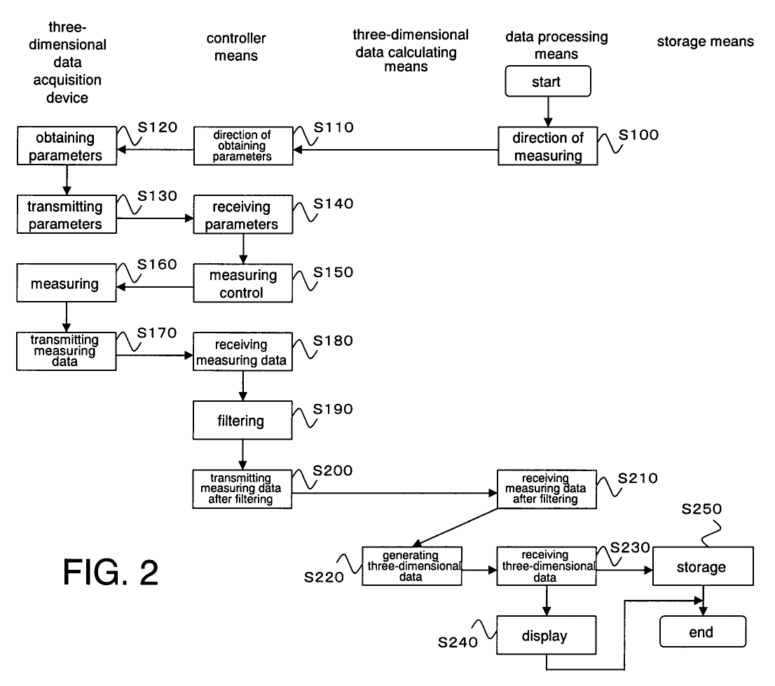

Now an embodiment of process flow of the measuring processing in the three-dimensional measuring equipment 1 in accordance with the present invention will be described in greater detail with reference to the schematic block diagram of FIG. 2 and the system overview of FIG. 1. Before capturing the image of the object, the measuring camera 8 is assumed to be installed at a given position in the space, and the object is assumed to be placed within the space.

The data processing means 5 of the three-dimensional data processing device 3 issues the measuring instruction to the controller means 4 for starting the measurement of the object (S100), the controller means 4, upon reception of the instruction, in turn directs the object position measuring sensor 10 of the three-dimensional data acquisition device 2, the measuring camera 8 or the measuring camera position measuring sensor 9 to obtain parameters so as to detect the position of the object in the space, the position, inclination, direction of light axis, and magnification of the measuring camera 8 in the space (S110).

The three-dimensional data acquisition device 2 having received the parameter retrieval instruction detects the position of the object in the space by means of the object position measuring sensor 10, and detects the position, inclination, direction of light axis, magnification and the like of the measuring camera 8 by using the measuring camera 8 or the measuring camera position measuring sensor 9 (S120) to transmit data to the controller means 4 (S130).

After receiving the parameters such as the position of the object in the space, the position, inclination, direction of light axis, and magnification of the measuring camera 8 in the space in the controller means 4 (S140), the controller means 4 controls the combination of the light source 14 and the measuring camera 8 and the measuring time to direct the measuring camera 8 to capture the image of the object to obtain the measuring data (S150).

More specifically, from the parameters such as the position, inclination, direction of light axis, and magnification of the measuring camera 8 in the space, a combination of a light source 14 and a measuring camera 8 is extracted so as to control the image capturing sequence and the measuring timing. The combination of a light source 14 and a measuring camera 8 may be any arbitrary one if the measuring camera 8 is equipped with a lens or a filter for applying time-division and/or space-division, while on the other hand a combination with the measuring camera 8 is determined such that the stripe patterns 15 projected onto the object from the light source 14 do not overlap with each other on the object.

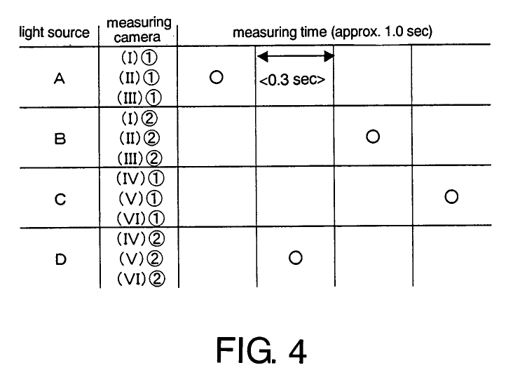

For instance, when extracting a combination of the measuring camera with the light source 14 having no overlap, the measuring cameras 8 are placed as shown in FIG. 1 on support struts (I) to (VI) in the space of the three-dimensional data acquisition device 2, one at top and one at bottom, and the light sources 14 are placed on the struts (II) and (V), one at top and one at bottom, the image of the same side of an object can be captured from two different angles. The controller means 4 then determines the sequence and combination as shown in FIG. 4 to control the measuring cameras 8 to capture the image of the object to obtain the measuring data. In the example shown in FIG. 4, a stripe pattern 15 is project onto the object using the light source A, then is captured by the measuring cameras 8 (I) (1), (II) (1), (III) (1) placed on the top of the struts (I) to (III). Next, the light source D is used to project the stripe pattern 15 onto the object, the stripe pattern 15 is captured by the measuring cameras 8 (IV) (2), (V) (2), (VI) (2) placed at the bottom of the struts (IV) to (VI). Next, the light source B is used to project the stripe pattern 15 onto the object, the stripe pattern 15 is captured by the measuring cameras 8 (I) (2), (II) (2), (III) (2) placed at the bottom of the struts (I) to (III). Finally the light source C is used to project the stripe pattern 15 on the object, the stripe pattern 15 is captured by the measuring cameras 8 (IV) (1), (V) (1), (VI) (1) placed at the top of the struts (IV) to (VI).

As can be appreciated, the light sources 14 project the stripe pattern 15 onto the object sequentially such that the light sources 14 do not overlap with each other on the object and the measuring cameras 8 captures the pattern. As have been described above, not only one light source 14 projects the stripe pattern 15 onto the object at a time, but the light source A and light source D, or the light source B and light source C may be simultaneously used to capture the stripe pattern 15 by the measuring cameras 8 under the condition that the stripe patterns 15 do not overlap with each other on the object.

If the measuring cameras 8 is equipped with a lens or a filter for time-division and/or space-division, the stripe pattern 15 projected on the object can be captured by any extracted arbitrary combination of measuring cameras 8. For example, a combination of measuring cameras 8 and light sources 14 opposing each other inline across the object can be used for the image capturing. In this case, the stripe patterns 15 projected by the light sources 14 each placed at the opposed side to the measuring camera 8 are time-divided and/or space-divided so as to prevent the interference there between.

More specifically, the measuring cameras 8 of the three-dimensional data acquisition device 2 captures the stripe pattern 15 on the object under the control S150 of the controller means 4 of the three-dimensional data processing device 3 to obtain the measuring data (S160) and to transmit the data to the three-dimensional data processing device 3 (S170).

The controller means 4 having received the measuring data from the three-dimensional data acquisition device 2 (S180) performs a series of filtering on the measuring data (S190), then it sends filtered measuring data to the data processing means 5 (S200).

The data processing means 5, upon reception of the filtered measuring data (S210), creates three-dimensional data such as three-dimensional coordinates, texture data, or wire-frames in the three-dimensional data calculating means 6 based on the measuring data (S220). When generating three-dimensional data from the measuring data, the point-group data is converted based on the filtered measuring data, then each of data items is rotated/translated thereon, then synthesized and smoothen to create the contour line data (or three-dimensional data).

More specifically, the measuring data (images) of the stripe pattern 15 captured by the measuring cameras 8 is processed to extract the position of the stripes, then detect the amount of deviation of the point from the reference point to derive three-dimensional data based on the coordinate equation. For instance, when measuring a cylindrical column as shown in FIG. 9, the measuring data captured (image) is vertically scanned at a given interval to extract the centers of either white stripes or black stripes to detect the amount of deviation from the ideally original position of the stripes (the position to be projected on a reference plane, or the position projected onto the background). The depth may be calculated based on the principle of triangulation. By substituting the deviation and the two-dimensional coordinates of the center into the equation to obtain the three-dimensional data. When such a method is used, the coordinate density in the horizontal direction will depend on the resolution (for example, 512 pixels) of the measuring data (image), and the density in the vertical direction will depend on the number of stripes projected. Accordingly in order to improve the resolution in the vertical direction, the width of the stripe pattern 15 should be narrowed. The schematic diagram of the case is shown in FIGS. 10 (a) and (b).

When the width of the stripe pattern 15 is narrower, the extraction of the center of the stripe will be difficult if it is too narrower (particularly in case of an object having a complex shape), so that there is a limit. To overcome this limitation, the three-dimensional data calculating means 6 calculates the coordinates based on a plurality of shots (preferably four) of measuring data (images) with the generated grid being shifted by an arbitrary amount based on the stripe pattern 15 projected (this is referred to as stripe scan method). By using the stripe scan method the density of the stripe will be normalized from a plurality of shots of measuring data (images) to detect the phase of the stripes, allowing the coordinates of every points on the measuring data (images) to be calculated as shown in FIG. 10 (c). In addition, during the normalization of the stripes, the effect of any design pattern on the surface of the object can be eliminated. Because the scan of the stripe may obtain the amount of deformation of the stripes that are used as the basis of the coordinate calculation at a higher sensitivity, many detailed irregularities can be detected.

Furthermore, only one image may be used to derive three-dimensional data calculation at a higher density. This can be achieved by using the methodology of frequency analysis, by calculating the coordinates from the grid projected on one image. This allows a moving object to be measured. In addition, the image of the stripe pattern 15 may also be filtered in the controller means 4 to remove the noise component to extract only the stripe information to eliminate the effect of the design pattern, while calculating the coordinates on the entire imaged area.

After having generated three-dimensional data in the three-dimensional data calculating means 6, the three-dimensional data calculating means 6 transmits the three-dimensional data created to the data processing means 5, and the data processing means 5 receives the data (S230). The data processing means 5 displays the three-dimensional display of the object based on the received three-dimensional data (S240). The data processing means 5 may also transmits the three-dimensional data to the storage means 7 to store it therein (S250).

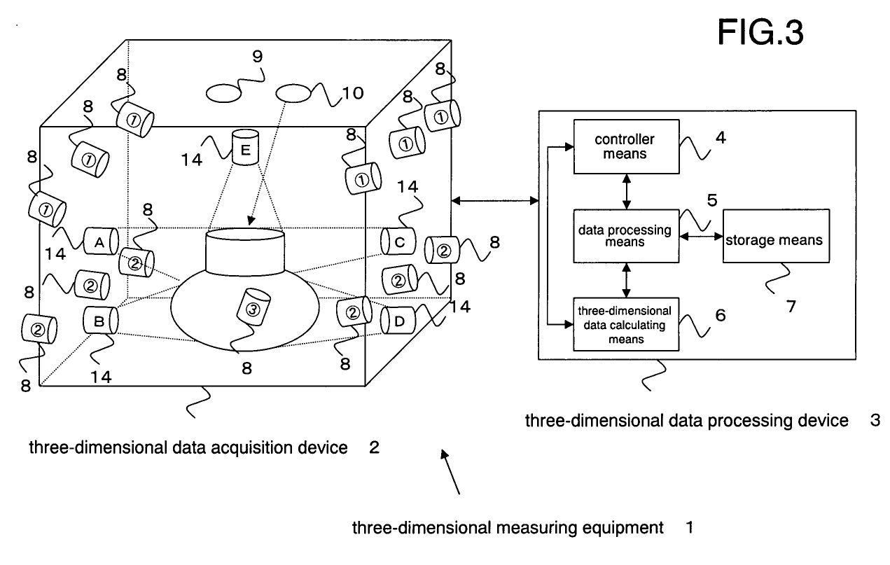

With the process and system arrangement as have been described above, the measuring cameras 8 may be placed at a given position and the three-dimensional data may be generated with a complex shape of an object. More specifically, as the position of the measuring cameras 8 in the space can be detected, the relative position in the space of the measuring data imaged can be determined. From this, the relationships between relative positions in the measuring data imaged by the measuring cameras 8 or the absolute position in the space can be determined, so that the three-dimensional data of the object can be created. As shown in FIG. 3, if capturing the image of the inside of an object, such as a jar, is required, light sources 14 are provided so as to project the stripe pattern 15 inside the object, and measuring cameras 8 are placed inside the object to capture the stripe pattern 15 projected to generate three-dimensional data from within the inside of the object, while the prior art generates only three-dimensional data of the outside surface of the object.

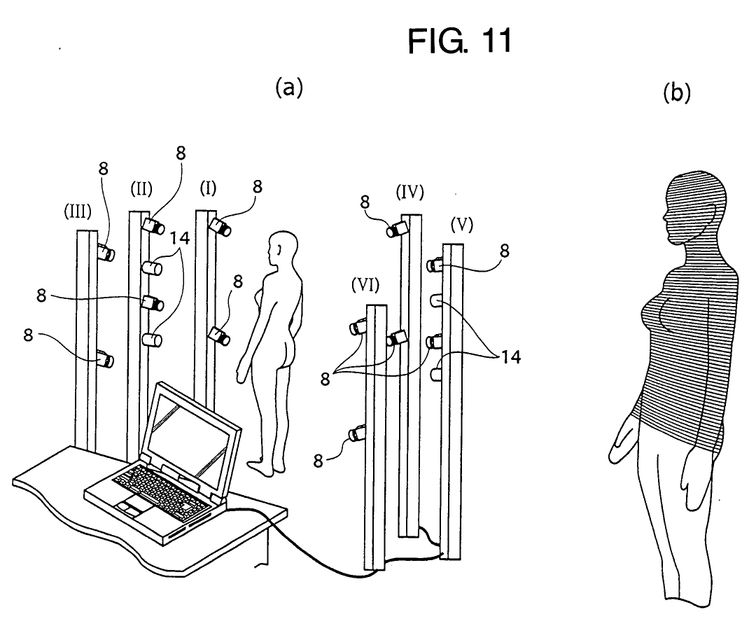

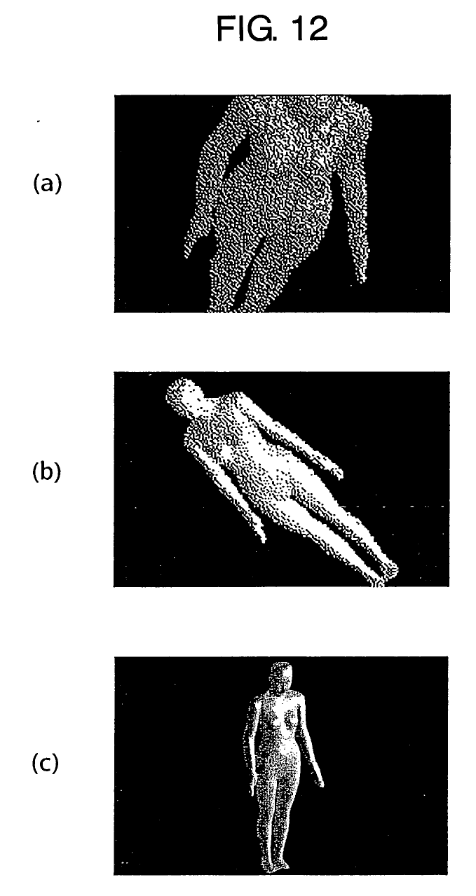

A schematic diagram is shown in FIG. 11 for measuring for example a human body. FIG. 11 (a) shows a schematic diagram for the case when capturing the image of a human body using the three-dimensional data acquisition device 2 shown in FIG. 1 with the arrangement of light sources 14 and measuring cameras 8, and FIG. 11 (b) shows a schematic diagram for the case when projecting the stripe pattern from the light source A and capturing the image of the human body with the measuring cameras 8 (I) (1) TO (iii) (1), in the arrangement shown in FIG. 11 (a). The three-dimensional data generated by the three-dimensional data processing device 3 based on the measuring data thus images is shown in FIG. 12. FIG. 12 (a) shows a schematic diagram illustrating the polygonal display, FIGS. 12 (b) and (c) show schematic diagrams illustrating three-dimensional displays.

When the object is moving within the space, it may be possible that the object position measuring sensor 10 always tracks and detects the position of the object to transmit to the three-dimensional data processing device 3 whenever necessary, the controller means 4 moves the measuring cameras 8 or changes the inclination, direction of light axis, magnification of the measuring cameras 8 along with the movement of the object to trace the object to be imaged. In such a case the displacement of the object is captured at a predetermined interval (for example, 0.1 second interval) by the measuring cameras 8, the three-dimensional data may be generated from the measuring data of each camera, and by continuously displaying the three-dimensional data, the three-dimensional data can be displayed as a pseudo movie.

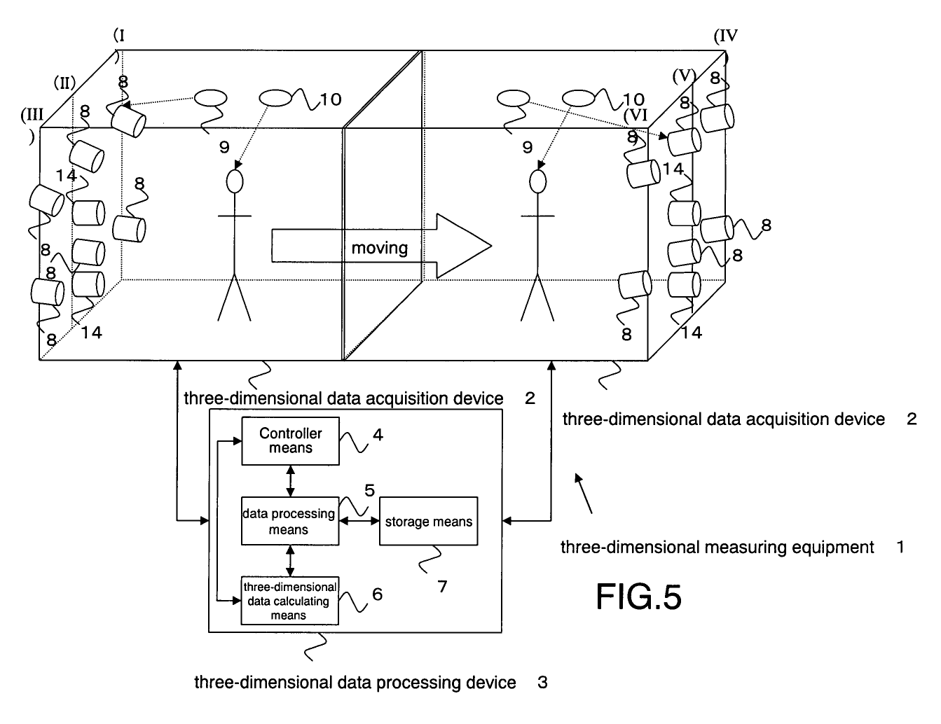

It may also be possible that a plurality of three-dimensional data acquisition devices 2 are contiguously arranged to form a three-dimensional measuring equipment 1, which enables the transmission and reception of data to and from the three-dimensional data processing device 3, without displacing the measuring cameras 8 themselves. FIG. 5 shows a schematic diagram illustrating the three-dimensional measuring equipment 1 in this arrangement. The system overview in this arrangement is shown in FIG. 5. With this configuration, while the object moves within the space of the three-dimensional data acquisition device 2, where the measuring cameras 8 are installed, the movement of the object is captured at a predetermined interval (for example, 0.1 second interval) by the measuring cameras 8 to generate three-dimensional data from the measuring data of each camera to enable continuously displaying the three-dimensional data, the three-dimensional data display will be like a motion picture.

When the object moves as have been described above, the measuring cameras 8 may capture some predetermined responses (for example, information on some specific colors) to automatically perform capturing the image, and dynamically change the measuring precision or the synthetic scheme of three-dimensional images. More specifically, since the present invention uses the process as described above to obtain the texture, different from the prior art, the above determination can be done on the color information included in the measuring data captured (images).

The control in case of automated capturing an image for example may be such that the measuring camera 8 take shots if predetermined color information is included within the capturing area of the measuring camera 8 (in this case, it will be needless to say that the light sources 14 projects the stripe pattern 15 all the time or as required) to generate the measuring data (images), which is the base of the three-dimensional images.

When the capturing an image is automated as have been described above, the measuring cameras 8 may unnecessarily capture the image of measuring data (images) not required for the three-dimensional image generation. The measuring data (images) captured by the measuring cameras 8 to be used may be distinguished from the measuring data (images) captured by the measuring cameras 8 not to be used. More specifically, if the measuring camera 8 automatically capturing an image when the object is moving, the measuring data (images) to be used should be distinguished from the measuring data (images) not to be used. However in accordance with the present invention, since the texture data can be obtained, if any predetermined color (color information) is detected in the captured measuring data, the measuring data (images) are classified as the data (images) to be used. For generating three-dimensional images, the measuring data (images) may be determined whether or not to be used based on the color information distinguished by the texture from a plurality of shots of measuring data (images).

In addition, as have been described above, since the present invention can obtain the texture data, a variety of controls based on the color information will be achievable. For example, a predetermined color is detected within the capturing area of a measuring camera 8, more specifically a predetermined color (color information) is detected in the captured measuring data as the texture of measuring data (images), some control such as switching on or off or changing the magnification of a specific measuring camera 8 can be performed. This allows a zooming images to be taken with the focus on the object including a specific color.

In addition to the automated distinction of the measuring data (images) taken by the measuring cameras 8, the present invention allows an operator to observe the measuring data to determine whether the data is to be used or not to be used.

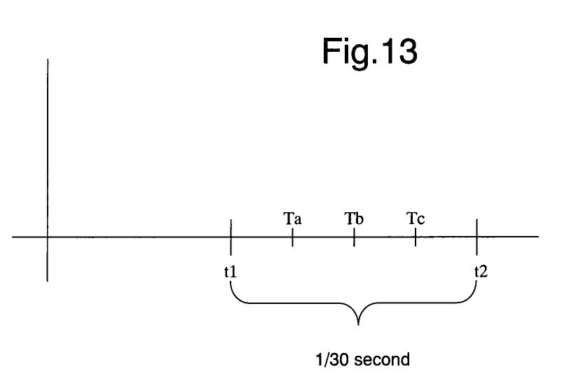

The present invention is also characterized by its very fast capturing the image of the object, as have been described above. If the object is moving for example, the three-dimensional images describing the moving object may also be generated. For instance, when three measuring cameras 8 are used to capture the image of a moving object, if the measuring cameras 8 at three different locations (measuring camera a, measuring camera b, and measuring camera c) will capture the image at the interval less than 1/30 second to generate measuring data Ta, Tb, Tc, respectively, the three-dimensional data calculating means 6 uses the data Ta, Tb, Tc as the measuring data taken at the same time to generate three-dimensional data to create a moving picture at the video rate. In other words, even when the exact moment at which each measuring camera 8 takes captures may be actually somewhat different, when the data is to be processed for a moving picture, as the images are to be succeedingly taken one after another at a predetermined interval (for instance 1/30 second for the video rate), the actual capturing of image should be done within this interval to assume these are taken at the same time, and these data items are assembled to one three-dimensional data to allow creating three-dimensional images depicting the moving object as the substantial moving picture. This is shown in FIG. 13.

The means in accordance with the present invention have solely their function logically distinguished, and may be physically or virtually unified to a unique domain.

To embody the present invention, a recording medium including a software program recorded thereon for achieving the functionality of the preferred embodiment may be supplied to the system, and the computer within the system, needless to say, reads the program stored on the recording medium and run it to achieve the functionality.

As the program itself, which is read out from the recording medium, achieves the functionality of the preferred embodiment, the recording medium storing the program thereon also constitutes the present invention.

Some examples of recording medium for supplying the program may include, among others, a magnetic disk, a hard disk, an optical disk, a magneto-optical disk, a magnetic tape, a non-volatile memory card and the like.

It will be also appreciated that the functionality of the preferred embodiment mentioned above can be achieved not only by executing the program read out by the computer, but also by the operating system running on the computer under the instruction of the program, executing part or all of the actual processing, which processing achieves the functionality of the preferred embodiment as have been described above.

It should be appreciated that the program read out from the recording medium may also be written into a storage means of volatile or non-volatile nature, equipped with an expansion board installed in the computer or an extension unit connected to the computer, then under the instructions of the program the CPU incorporated in the expansion card or the extension unit executes part or all of the actual processing, which processing embodies the functionality of the preferred embodiment as have been described above.

### AVAILABILITY IN THE INDUSTRIES

In accordance with the present invention, a three-dimensional measuring equipment is provided, which conveniently and rapidly measures the three-dimensional surface shape with high accuracy and high efficiency, even when the object has a complex surface shape.

In addition, if the object is moving, the measurement of moving object also is allowed by displacing measuring cameras along with the movement of the object.

1. A three-dimensional measuring equipment, comprising of a three-dimensional data acquisition device for measuring the three-dimensional surface shape of an object and a three-dimensional data processing device for generating three-dimensional data based on the measuring result,
said three-dimensional data acquisition device comprising:
a plurality of light sources each provided at a given position in a space, for projecting a stripe pattern onto said object;
a plurality of measuring cameras each provided at a given position in said space for capturing the stripe pattern projected onto said object and for detecting a part or all of the position, inclination, direction of light axis, magnification of the camera within said space,
said three-dimensional data processing device comprising:
controller means for directing said measuring cameras to obtain a part or all of parameters of the position, inclination, direction of light axis, magnification of said measuring cameras within said space, for obtaining said parameters from said measuring cameras, for extracting the combinations of said light source for projecting the stripe pattern to said object and said measuring camera for capturing said stripe pattern based on said parameters, for performing control of sequential order and measuring time of said measuring cameras for capturing, and for capturing the stripe pattern of said object by means of said measuring cameras, to thereby obtain the measuring data;
three-dimensional data calculating means for generating three-dimensional data based on said measuring data;
data processing means for performing three-dimensional display of said object based on said three-dimensional data; and
storage means for storing said three-dimensional data generated.

2. A three-dimensional measuring equipment comprising of a three-dimensional data acquisition device for measuring the three-dimensional surface shape of an object and a three-dimensional data processing device for generating three-dimensional data based on the measuring result,
said three-dimensional data acquisition device comprising:
a plurality of light sources each provided at a given position in a space, for projecting a stripe pattern onto said object;
a plurality of measuring cameras each provided at a given position in said space, for capturing the stripe pattern projected onto said object; and
at least one or more measuring camera position measuring sensors each provided at a given position in said space, for detecting a part or all of the position, inclination, direction of light axis, magnification of said measuring cameras in said space,
said three-dimensional data processing device comprising:
controller means for directing said measuring camera position measuring sensors to obtain a part or all of parameters of the position, inclination, direction of light axis, and magnification of said measuring cameras in said space, for obtaining said parameters from said measuring camera position measuring sensors, for extracting the combination of said light source for projecting the stripe pattern onto said object and said measuring camera for capturing said stripe pattern, for performing the control of sequential order and measuring time of said measuring cameras for capturing, and for capturing the stripe pattern of said object by means of said measuring cameras, to thereby obtain the measuring data;
three-dimensional data calculating means for generating three-dimensional data based on said measuring data;
data processing means for performing three-dimensional display of said object based on said three-dimensional data; and
storage means for storing said three-dimensional data generated.

3. A three-dimensional measuring equipment comprising a three-dimensional data acquisition device for measuring the three-dimensional surface shape of an object and a three-dimensional data processing device for generating three-dimensional data based on the measuring result,
said three-dimensional data acquisition device comprising:
at least one or more object position measuring sensors each provided at a given position in a space for detecting the position of said object in said space;
a plurality of light sources each provided at a given position in a space, for projecting a stripe pattern onto said object; and
a plurality of measuring cameras each provided at a given position in said space, for capturing said stripe pattern projected to said object and for detecting a part or all of parameters of the position, inclination, direction of light axis, and magnification of the camera in said space,
said three-dimensional data processing device comprising:
controller means for directing said object position measuring sensor and said measuring cameras to obtain a part or all of the parameters of the position of said object in said space, the position, inclination, direction of light axis, magnification of said measuring camera in said space, for obtaining said parameters from said object position measuring sensors and said measuring cameras, for extracting the combination of the light source projecting the stripe pattern onto said object and said measuring camera capturing said stripe pattern based on said parameters, for performing the control of sequential order and measuring time of capturing said measuring cameras for capturing, and for capturing the stripe pattern of said object by means of said measuring cameras, to thereby obtain the measuring data;
three-dimensional data calculating means for generating three-dimensional data based on said measuring data;
data processing means for performing three-dimensional display of said object based on said three-dimensional data; and
storage means for storing said three-dimensional data generated.

4. A three-dimensional measuring equipment comprising a three-dimensional data acquisition device for measuring the three-dimensional surface shape of an object and a three-dimensional data processing device for generating three-dimensional data based on the measuring result,
said three-dimensional data acquisition device comprising:
at least one or more object position measuring sensors each provided at a given position in a space, for detecting the position of said object in said space;
a plurality of light sources each provided at a given position in said space, for projecting a stripe pattern onto said object;
a plurality of measuring cameras each provided at a given position in said space, for capturing the stripe pattern projected onto said object; and
at least one or more measuring camera position measuring sensors each provided at a given position in said space, for detecting a part or all of the parameters of the position, inclination, direction of light axis, magnification of said measuring cameras in said space,
said three-dimensional data processing device comprising:
controller means for directing said object position measuring sensors and said measuring camera position measuring sensors to obtain a part or all of the parameters of the position of said object in said space, and the position, inclination, direction of light axis, magnification of said measuring cameras in said space, for obtaining said parameters from said object position measuring sensors and said measuring camera position measuring sensors, for extracting the combination of said light source projecting the stripe pattern onto said object and said measuring camera capturing said stripe pattern based on said parameters, for performing the control of sequential order and measuring time of capturing said measuring cameras for capturing, and for capturing the stripe pattern of said object by said measuring camera, to thereby obtain measuring data;
three-dimensional data calculating means for generating three-dimensional data based on said measuring data;
data processing means for performing three-dimensional display of said object based on said three-dimensional data; and
storage means for storing said three-dimensional data generated.

5. A three-dimensional measuring equipment in accordance with claim 3 or claim 4, wherein
the measuring camera moves under the control of the controller means based on the position of the object detected by the object position measuring sensors, for capturing the stripe pattern.

6. A three-dimensional measuring equipment in accordance with claim 3 or claim 4, wherein
said measuring camera alters the inclination, direction of light axis, and magnification under the control of said controller means based on the position of said object detected by said object position measuring sensors for capturing said stripe pattern.

7. A three-dimensional measuring equipment in accordance with any one of claims 1 to 4, wherein
the three-dimensional data calculating means performs the conversion of point-group data, rotation and translation after conversion, synthesizing and smoothing, based on said measuring data, for generating three-dimensional data.

8. A three-dimensional measuring equipment in accordance with any one of claims 1 to 4, wherein
when the controller means extracts the combination of said light source and said measuring camera, it extracts a combination such that the stripe patterns projected by said light source do not overlap with each other on the object.

9. A three-dimensional measuring equipment in accordance with any one of claims 1 to 4, wherein
when extracting the combination of the light source and the measuring camera,
if the measuring camera has a lens or filter that blocks the light of a specific frequency or a color filter that blocks a specific color,
the controller means extracts appropriately a combination of the light source and the measuring camera.

10. A three-dimensional measuring equipment in accordance with any one of claims 1 to 4, wherein
the measuring camera has a lens or filter that extracts a specific phase,
the controller means controls, in a time-division manner, switching on and off the function of said lens or filter that extracts a specific phase.

11. A three-dimensional measuring equipment in accordance with any one of claims 1 to 4, wherein
the controller means performs the control of the measuring cameras based on the color information contained in the measuring data.

12. A three-dimensional data acquisition device for performing the measurement of the three-dimensional surface shape of an object under the control of a three-dimensional data processing device, for generating three-dimensional data,
said three-dimensional data acquisition device comprising:
a plurality of light sources each provided at a given position in a space, for projecting a stripe pattern onto said object;
a plurality of measuring cameras each provided at a given position in said space, for capturing the stripe pattern projected onto said object and for detecting a part or all of the parameters of the position, inclination, direction of light axis, magnification of the camera in said space.

13. A three-dimensional data acquisition device for performing the measurement of the three-dimensional surface shape of an object under the control of a three-dimensional data processing device, for generating three-dimensional data,
said three-dimensional data acquisition device comprising:
a plurality of light sources each provided at a given position in a space, for projecting a stripe pattern onto said object;
a plurality of measuring cameras each provided at a given position in said space, for capturing the stripe pattern projected onto said object;
at least one or more measuring camera position measuring sensors each provided at a given position in said space, for detecting a part or all of the parameters of the position, inclination, direction of light axis, magnification of said measuring camera in said space.

14. A three-dimensional data acquisition device for performing the measurement of the three-dimensional surface shape of an object under the control of a three-dimensional data processing device, for generating three-dimensional data, comprising:
at least one or more object position measuring sensors each provided at a given position in a space, for detecting the position of said object in said space,
a plurality of light sources each provided at a given position in said space, for projecting a stripe pattern onto said object;
a plurality of measuring cameras each provided at a given position in said space, for capturing the stripe pattern projected onto said object and for detecting a part or all of the parameters of the position, inclination, direction of light axis, magnification of the camera in said space.

15. A three-dimensional data acquisition device for performing the measurement of the three-dimensional surface shape of an object under the control of a three-dimensional data processing device, for generating three-dimensional data, comprising:
at least one or more object position measuring sensors each provided at a given position in a space, for detecting the position of said object in said space;
a plurality of light sources each provided at a given position in said space, for projecting a stripe pattern onto said object;
a plurality of measuring cameras each provided at a given position in said space, for capturing the stripe pattern projected onto said object; and
at least one or more measuring camera position measuring sensors each provided at a given position in said space, for detecting a part or all of the parameters of the position, inclination, direction of light axis, magnification of said measuring camera in said space.

16. A three-dimensional data acquisition device in accordance with claim 14 or claim 15, wherein
the measuring camera moves under the control of the controller means based on the position of the object detected by the object position measuring sensor, to thereby capture the stripe pattern.

17. A three-dimensional data acquisition device in accordance with claim 14 or claim 15, wherein
the measuring camera alters its inclination, direction of light axis, and magnification under the control of the controller means based on the position of the object detected by said object position measuring sensor, to thereby capture the stripe pattern.

18. A three-dimensional data processing device for generating three-dimensional data based on the result obtained from a three-dimensional data acquisition device for capturing the three-dimensional surface shape of an object,
said three-dimensional data processing device comprising:
controller means for directing a plurality of measuring cameras each provided at a given position in a space of said three-dimensional data acquisition device for capturing the stripe pattern of said object projected by a plurality of light sources each provided at a given position in said space of said three-dimensional data acquisition device for projecting the stripe pattern onto said object, and for detecting a part or all of the parameters of its position, inclination, direction of light axis, magnification in said space to obtain a part or all of the parameters of the position, inclination, direction of light axis, magnification of said measuring cameras in said space, for obtaining said parameters from said measuring cameras, for extracting the combination of the light source projecting the stripe pattern onto said object and said measuring camera capturing said stripe pattern, based on said parameters, for performing the control of sequential order and measuring time of said measuring cameras for capturing, and for capturing the stripe pattern of said object by means of said measuring cameras, to thereby obtain measuring data;
three-dimensional data calculating means for generating three-dimensional data based on said measuring data;
data processing means for performing three-dimensional display of said object based on said three-dimensional data; and
storage means for storing said three-dimensional data generated.

19. A three-dimensional data processing device for generating three-dimensional data based on the result obtained from a three-dimensional data acquisition device for capturing the three-dimensional surface shape of an object,
said three-dimensional data processing device comprising:
controller means for directing measuring camera measuring position sensors for detecting a part or all of parameters of the position, inclination, direction of light axis, magnification, in a space of said three-dimensional data acquisition device, of a plurality of measuring cameras each provided at a given position in said space of said three-dimensional data acquisition device for capturing the stripe pattern of said object projected thereon by a plurality of light sources each provided at a given position in said space of said three-dimensional data acquisition device for projecting the stripe pattern onto said object to obtain a part or all of the parameters of the position, inclination, direction of light axis, magnification of said measuring cameras in said space, for obtaining said parameters from said measuring camera measuring position sensors, for extracting the combination of the light source projecting the stripe pattern onto said object and said measuring camera capturing said stripe pattern based on said parameters, for performing the control of sequential order and measuring time of said measuring cameras for capturing, and for capturing the stripe pattern of said object by means of said measuring cameras, to thereby obtain measuring data;
three-dimensional data calculating means for generating three-dimensional data based on said measuring data;
data processing means for performing three-dimensional display of said object based on said three-dimensional data; and
storage means for storing said three-dimensional data generated.

20. A three-dimensional data processing device for generating three-dimensional data based on the result obtained from a three-dimensional data acquisition device for capturing the three-dimensional surface shape of an object,
said three-dimensional data processing device comprising:
controller means for directing at least one or more object position measuring sensors each provided at a given position in a space of said three-dimensional data acquisition device for detecting the position of said object and a plurality of measuring cameras each provided at a given position in said space of said three-dimensional data acquisition device for capturing the stripe pattern of said object projected by a plurality of light sources each provided at a given position in said space of said three-dimensional data acquisition device for projecting the stripe pattern onto said object and for detecting a part or all of the parameters of its position, inclination, direction of light axis, magnification in said space to obtain part or all of the parameters of the position of said object in said space, and the position, inclination, direction of light axis, magnification of said measuring cameras in said space, for obtaining said parameters from said object position measuring sensors and said measuring cameras, for extracting the combination of the light source projecting the stripe pattern onto said object and said measuring camera capturing said stripe pattern based on said parameters, for performing the control of sequential order and measuring time of said measuring cameras for capturing, and for capturing the stripe pattern of said object by means of said measuring cameras, to thereby obtain said measuring data;
three-dimensional data calculating means for generating three-dimensional data based on said measuring data;
data processing means for performing three-dimensional display of said object based on said three-dimensional data; and
storage means for storing said three-dimensional data generated.

21. A three-dimensional data processing device for generating three-dimensional data based on the result obtained from a three-dimensional data acquisition device for capturing the image of the three-dimensional surface shape of an object,
said three-dimensional data processing device comprising:
controller means for directing at least one or more object position measuring sensors each provided at a given position in a space of said three-dimensional data acquisition device for detecting the position of said object and a plurality of measuring camera measuring position sensors each provided at a given position in said space of said three-dimensional data acquisition device for detecting a part or all of the parameters of the position, inclination, direction of light axis, magnification, in said space of said three-dimensional data acquisition device, of a plurality of measuring cameras each provided at a given position in said space of said three-dimensional data acquisition device for capturing the stripe pattern of said object projected by a plurality of light sources each provided at a given position in said space of said three-dimensional data acquisition device for projecting the stripe pattern onto said object to obtain a part or all of the parameters of the position of said object in said space and the position, inclination, direction of light axis, magnification of said measuring cameras in said space, for obtaining said parameters from said object position measuring sensors and said measuring camera measuring position sensors, for extracting the combination of the light source projecting the stripe pattern onto said object and said measuring camera capturing said stripe pattern based on said parameters, for performing the control of the sequential order and measuring time of said measuring cameras for capturing, and for capturing the stripe pattern of said object by means of said measuring cameras to obtain measuring data;
three-dimensional data calculating means for generating three-dimensional data based on said measuring data;
data processing means for performing three-dimensional display of said object based on said three-dimensional data; and
storage means for storing said three-dimensional data generated.

22. A three-dimensional data processing device in accordance with any one of claims 18 to 21, wherein
the three-dimensional data calculating means performs the conversion of point-group data, rotation and translation after conversion, synthesizing and smoothing, based on said measuring data, for generating three-dimensional data.

23. A three-dimensional data processing device in accordance with any one of claims 18 to 21, wherein
when the controller means extracts the combination of said light source and said measuring camera, it extracts a combination such that the stripe patterns projected by the light source do not overlap with each other on the object.

24. A three-dimensional data processing device in accordance with any one of claims 18 to 21, wherein
when extracting the combination of the light source and the measuring camera,
if said measuring camera has a lens or filter that blocks the light of a specific frequency or a color filter that blocks a specific color,
the controller means extracts appropriately a combination of said light source and said measuring camera.

25. A three-dimensional data processing device in accordance with any one of claims 18 to 21, wherein
the measuring camera has a lens or filter that extracts a specific phase,
the controller means controls, in a time-division manner, switching on and off the function of said lens or filter that extracts a specific phase.

26. A three-dimensional data processing device in accordance with any one of claims 18 to 21, wherein
the controller means performs the control of the measuring cameras based on the color information contained in the measuring data.
